(19) United States
(12) Patent Application Publication
(10) Pub. No.: US 2006/0054822 A1
(43) Pub. Date: Mar. 16, 2006

(54) Radiation detector and radiographic imaging system

(75) Inventor: Hisanori Tsuchino, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/222,364

(22) Filed: Sep. 8, 2005

(30) Foreign Application Priority Data
Sep. 16, 2004 (JP) 2004-269951
Sep. 29, 2004 (JP) 2004-283702

(51) Int. Cl. G01T 1/00; H02J 7/00

(52) U.S. Cl. 250/336.1; 320/112

(57) ABSTRACT

A radiation detector capable of appropriately performing charging or replacement of a battery depending on the situation. The detector includes: a replaceable battery, and a determination section to determine whether replacement of the battery is allowable or not.

### BACKGROUND OF THE INVENTION

1. Field of the Invention

The present invention relates to a radiation detector and a radiographic imaging system which is utilized at the time of radiographic imaging of a subject.

2. Description of Related Art

In the field of radiographic imaging for medical diagnosis, there has been widely known a radiographic imaging system in which a subject is irradiated with radiation and an intensity distribution of the radiation transmitted through the subject is detected to obtain a radiographic image of the subject. In a recent radiographic imaging system, there has been developed and used a radiation detector called a “flat panel detector”, which is formed into a thin flat plate having a large number of photoelectric conversion elements arranged thereon in a matrix. This radiation detector photoelectrically converts the radiation transmitted through the subject into electric signals, and performs image processing on the converted electric signals, thereby obtaining easily and rapidly the radiographic image of the subject.

The radiation detector is broadly classified into a stationary detector installed as a part of the system at a predetermined position and a portable (cassette type) detector capable of being freely carried. Both stationary and cassette type radiation detectors generally have their own built-in battery when it is driven as an independent detector. Some examples of such radiation detector are disclosed in JP 7-140255A, JP 2003-248060A and JP 2003-172783A.

A radiation detector disclosed in JP 7-140255A is a portable cassette type detector (a cassette 40 as a radiation detector). This radiation detector has a built-in battery (power supply 44) for driving photoelectric conversion elements (solid-state photo detecting elements 31) and the like, and is possible to supply power without connecting to an external signal processing device and a power supply with cables, so that flexibility for a radiographic imaging place is improved (see paragraph numbers 0033-0038).

A radiation detector disclosed in JP 2003-172783A is also a portable cassette type one (a cassette type radiographic image detector 1). This radiation detector has a display unit (charge state display means 8c) for displaying a charged state of a battery 16, and can visually recognize the charged state of the battery (paragraph number 0102).

On the contrary, a radiation detector disclosed in JP 2003-248060A is a radiation detector capable of using as both stationary and cassette type detector (X-ray imaging device). This radiation detector separately has an imaging unit (basic imaging unit 31) including photoelectric conversion elements 36b and the like, and a power supply unit (additional part 32) including a battery (battery circuit 47) and the like. In case of using the radiation detector as a stationary one, the imaging unit is installed on a bed 71 as a single unit, and power is supplied through a cable 77 (paragraph numbers 0026-0029). In case of using the radiation detector as a portable type detector, the imaging unit is integrated with the power supply unit for the power supply unit to supply power to the imaging unit (paragraph numbers 0016-0024).

In the radiation detector disclosed in JP 7-140255A, although the detector is portable, charging of the battery is carried out with the detector placed on a cradle, therefore the detector itself cannot be used during charging period. On the contrary, in the radiation detector disclosed in JP 2003-248060A, the power supply unit including a battery is attachable to and detachable from the imaging unit, thereby avoiding inconveniency that the detector cannot be used during charging period. However, it is not considered such inconveniency that occurs at the time of detaching/attaching the power supply unit from/to the imaging unit. That is, when the power supply unit is detached from the imaging unit while the radiation detector is communicating with a controller of an external device, or the detector is running, the above-described communication and the detection of radiation would be interrupted. Therefore, timing of detaching the power supply unit (namely, battery) from the imaging unit has to be properly assured, and attentiveness is required in charging or replacing the battery.

### SUMMARY OF THE INVENTION

An object of the invention is to provide a radiation detector capable of appropriately performing charging or replacement of a battery depending on the situation. Another object of the invention is to provide a radiation detector capable of preventing erroneous detachment of a battery.

In accordance with a first aspect of the invention, the radiation detector comprises: a replaceable battery; and a determination section to determine whether replacement of the battery is allowable or not.

According to the first aspect of the invention, the determination section determines whether the replacement of the battery is allowed or not. Therefore, with confirmation of a determination result of the determination section, charging or replacement of the battery can be appropriately performed depending on the situation, and further erroneous detachment of the battery can be prevented.

In accordance with a second aspect of the invention, the radiographic imaging system comprises a radiation detector and a console, capable of communicating with each other, wherein the radiation detector comprises: a replaceable battery, a determination section to determine whether replacement of the battery is allowable or not, and a detector interface to send a determination result of the determination section as a signal, to the console; and the console comprises: a console interface to receive the signal from the radiation detector, and a display unit to display the determination result of the determination section based on the received signal.

According to the second aspect of the invention, the display in the console displays a determination result of the determination section in the radiation detector. Therefore, with confirmation of the determination result, charging or replacement of the battery can be appropriately performed depending on the situation, and further erroneous detachment of the battery can be prevented.

In accordance with a third aspect of the invention, the radiation detector comprising: a replaceable battery; a volatile memory; a non-volatile memory; a switch to instruct data transfer from the volatile memory to the non-volatile memory; and a display unit to display a state that replacement of the battery is allowable, wherein the data transfer is performed from the volatile memory to the non-volatile memory by operation of the switch, and after the data transfer, the display unit displays a state that replacement of the battery is allowable.

According to the third aspect of the invention, after the data has been transferred from the volatile memory to the non-volatile memory with the operation of the switch, the display displays the state that the replacement of the battery is allowable, so that erroneous detachment of the battery can be prevented during the data transfer.

In accordance with a fourth aspect of the invention, the radiographic imaging system comprises a radiation detector and a console, capable of communicating with each other, wherein the radiation detector comprises: a replaceable battery, a volatile memory, a non-volatile memory, a switch to instruct data transfer from the volatile memory to the non-volatile memory, and a detector interface to send a state that replacement of the battery is allowable, as a signal to the console; and the console comprises: a console interface to receive the signal from the radiation detector, and a display unit to display the state that replacement of the battery is allowable, based on the received signal, and the radiation detector performs data transfer from the volatile memory to the non-volatile memory by operation of the switch, and after the data transfer, the display unit of the console displays a state that replacement of the battery is allowable.

According to the fourth aspect of the invention, after the data has been transferred from the volatile memory to the non-volatile memory with the operation of the switch, the display of the console displays the state that the replacement of the battery is allowable, so that erroneous detachment of the battery can be prevented during the data transfer.

### BRIEF DESCRIPTION OF THE DRAWINGS

The present invention will become more fully understood from the detailed description given below and the accompanying drawings which are given by way of illustration only, and thus are not intended to limit the scope of the invention, and wherein:

FIG. 1 is a view showing a schematic configuration of a radiographic imaging system;

FIG. 2 is a perspective view showing a schematic configuration of a radiation detector;

FIG. 3 is a perspective view showing a structure of a lock mechanism;

FIG. 4 is a block diagram showing a circuit configuration of the radiographic imaging system;

FIG. 5 is a flowchart showing in a time sequence a main routine that a controller of the radiation detector executes;

FIG. 6 is a flowchart showing in a time sequence each processing of a subroutine (initialize processing) that the controller of the radiation detector executes;

FIG. 7 is a flowchart showing in a time sequence each processing of a subroutine (display/lock control processing) that the controller of the radiation detector executes;

FIG. 8 is a view showing a screen to display a state that remaining power of a battery is insufficient and battery replacement is allowable;

FIG. 9 is a view showing a screen to display a state that the remaining power of a battery is sufficient and the battery replacement is allowable;

FIG. 10 is a view showing a screen to display a state that the remaining power of a battery is insufficient and the battery replacement is not allowable;

FIG. 11 is a view showing a screen to display a state that the remaining power of a battery is sufficient and battery replacement is not allowable; and

FIG. 12 is a flowchart showing in a time sequence each processing of a subroutine (processing associated with image data) that the controller of the radiation detector executes.

### DETAILED DESCRIPTION OF THE PREFERRED EMBODIMENTS

Preferred embodiments of the invention will be described below with reference to the accompanying drawings, and the scope of the invention is not limited to the exemplified drawings.

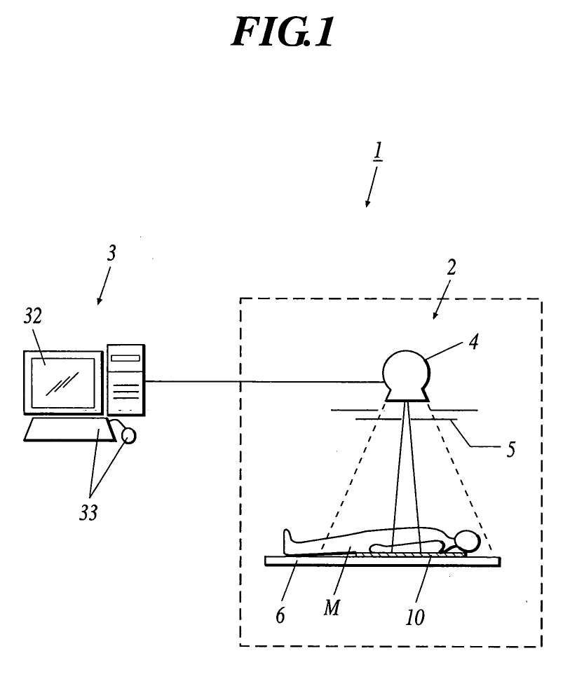

FIG. 1 is a view showing a schematic configuration of a radiographic imaging system 1.

As shown in FIG. 1, the radiographic imaging system 1 includes an imaging apparatus 2 for radiographing a subject M by irradiating radiation to the subject M, and a console 3 for generating a radiographic image of the subject M.

The imaging apparatus 2 is installed and used at a medical institution such as a medical office and a hospital. The imaging apparatus 2 includes a radiation source 4 that generates radiation with a tube voltage applied thereto. At a radiation aperture of the radiation source 4, there is provided a diaphragm 5 for adjusting an irradiating field of the radiation by opening/closing the aperture. Under the radiation source 4, there is provided a bed 6 on which the subject M is laid within an irradiating area of the radiation. On the bed 6, a radiation detector 10 is arranged for detecting the amount of radiation transmitted through the subject M. The radiation detector 10 is a portable cassette type radiation detector removably arranged on the bed 6.

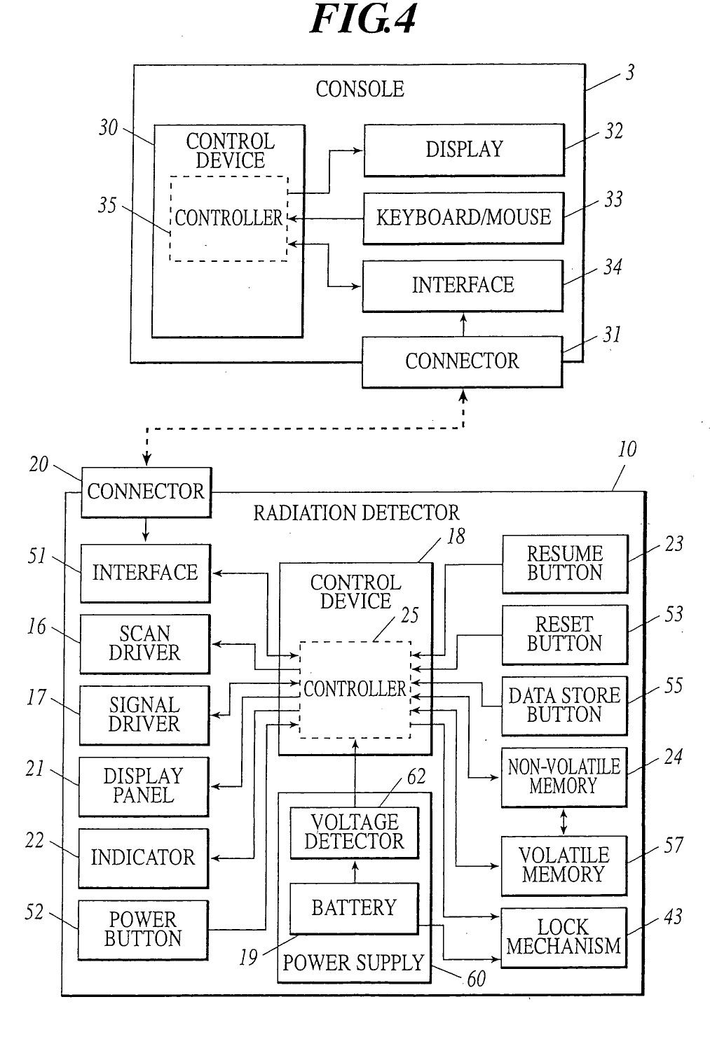

The console 3 is a general purpose computer, and includes a control device 30 (see FIG. 4) for generating a radiographic image of the subject M based on the detected result by the radiation detector 10, a connector 31 (see FIG. 4) for communicating with the imaging apparatus 2, a display 32 as a display unit for displaying the radiographic image of the subject M and the like, and keyboard/mouse 33 for inputting to the control device 30 imaging information relating to the subject M and the radiation detector 10.

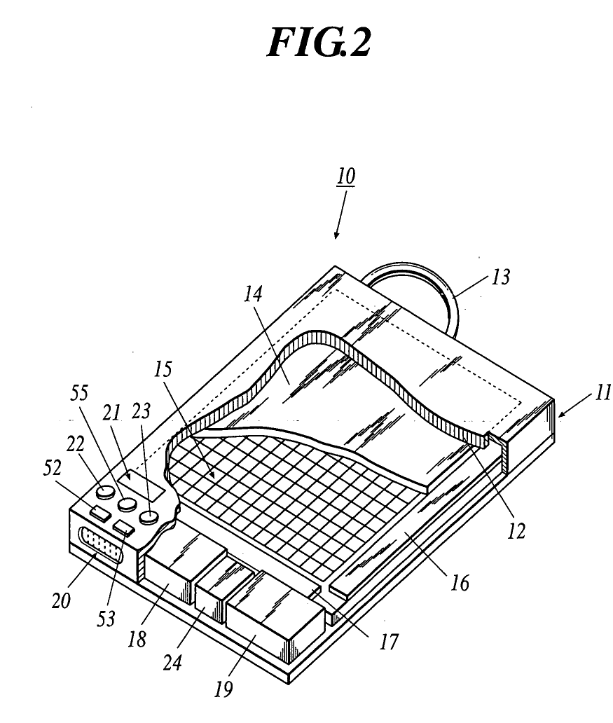

FIG. 2 is a perspective view showing a schematic configuration of the radiation detector 10 according to the invention.

As shown in FIG. 2, the radiation detector 10 has a thin parallelepiped housing 11, and a grid 12 as a part of a top plate of the housing 11 for absorbing and eliminating scattered components of the radiation. On one side of the housing 11, there is arranged a grip 13 so that the detector 10 can be easily carried.

Inside the housing 11, there is arranged a rectangular scintillator 14 to emit fluorescence having intensity according to intensity of the radiation incident thereto. The scintillator 14 contains phosphor, such as GOS (Gd₂O₂S: Tb) and CsI, or the like. Under or below the scintillator 14, there is arranged a flat-plated fluorescent detection panel 15 for detecting the fluorescence.

The fluorescent detection panel 15 has a large number of photoelectric conversion elements arranged thereon in a matrix (grid shape), the element receiving the fluorescence and storing electric energy according to the amount of receipt light. At side portions of the fluorescent detection panel 15, there are arranged a scan driver 16 to scan and drive the respective photoelectric conversion elements by sending pulses to the photoelectric conversion elements, and a signal driver 17 to read the electric energy stored in the respective photoelectric conversion elements.

Inside the housing 11, there are arranged a control device 18 for controlling operations of the scan driver 16, the signal driver 17 and other parts, a battery 19 as a power supply source, a non-volatile memory 24 and a volatile memory 25 (see FIG. 4).

The battery 19 is removably mounted (attached and detached) on the housing 11, and can be easily replaced with other battery 19.

The non-volatile memory 24 and the volatile memory 25 are both supplied power from the battery 19 to store various data. The non-volatile memory 24 consists of a solid-state memory such as a flash memory, and retains data as is stored before replacement of the battery 19 even if supplying of power is stopped due to replacement of the battery 19. On the other hand, the volatile memory 25 consists of a DRAM (dynamic random access memory), and loses data stored before replacement of the battery 19 when power is turned off due to replacement of the battery 19.

There are arranged on the housing 11 a connector 20 for communicating with the console 3, a display panel 21 as a display unit for displaying remaining power of the battery 19 and the like, an indicator 22 as a display unit for displaying a state that replacement of the battery 19 is allowable or not.

The indicator 22 has LEDs (light emitting diodes), which are lit “green” or “red”. The indicator 22 appropriately changes its color of light according to the state that replacement of the battery 19 is allowable or not. In detail, when the replacement of the battery 19 is allowable, it is lit green, and when not allowable, it is lit red.

Alternatively, lit color of the indicator 22 may be other colors than green and red, as long as the colors differ from each other to an extent that can determine whether replacement of the battery 19 is allowable or not. It is also possible that the indicator 22 may display only a state that the replacement of the battery 19 is allowable, or, on the contrary, only a state that the replacement of the battery 19 is not allowable. In this case, the states may be represented by “turned-on light” and “blinking”, “turned-on light” and “turned-off light”, or “blinking” and “turned-off light”.

On the housing 11, there are arranged, other than the parts described above, a power button 52 for switching ON/OFF the power supply of the radiation detector 10, a reset button 53 for resetting a running state of the detector 10 to a starting state, a data store button 55 as a switch for transferring data from the volatile memory 57 to the non-volatile memory 24, and a resume button 23 for, after replacement of the battery 19, resuming the running state of the detector 10 to the state before detaching the battery 19.

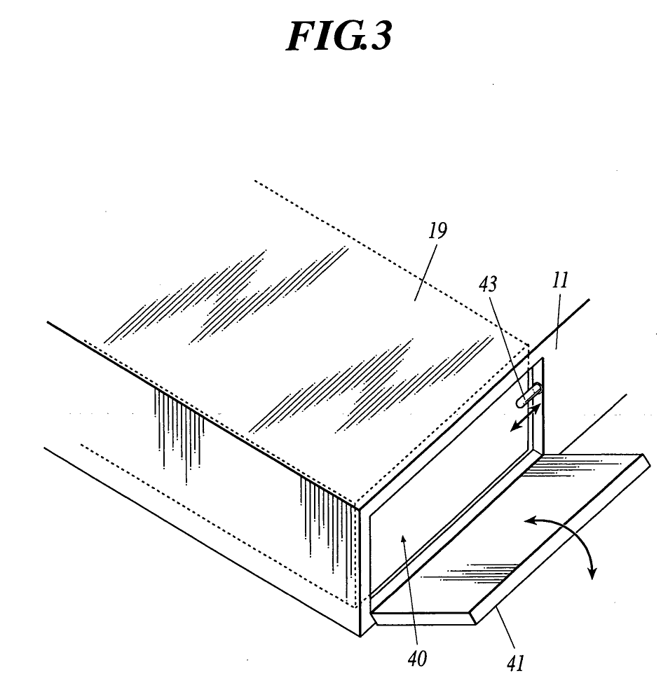

FIG. 3 is a perspective view showing a structure of the vicinity of the battery 19 in the detector 10, and mainly showing a lock mechanism for locking the battery 19.

As shown in FIG. 3, at a corner of the housing 11 of the detector 10, there is formed a rectangular opening 40 having a size with which the battery 19 can be inserted therein. A lid 41, capable of covering the opening 40, is coupled to the lower portion of the opening 40 through a hinge (not shown), and can be freely opened or closed against the opening 40. At one side of the opening 40 of the housing 11, there is arranged a lock mechanism 43.

The lock mechanism 43 is a nail-like member driven by an actuator (not shown) such as a solenoid as a driving source, and movable between a state projecting into the opening 40 and a state retracting inside the housing 11. The lock mechanism 43 projects into the opening 40 when the actuator is energized, and is retracted inside the housing 11 when the actuator is released from the operation. When the battery 19 is accommodated inside the housing 11 and the lock mechanism 43 projects, the battery 19 is locked in a state in which the battery 19 is not removable. On the contrary, when the lock mechanism 43 is retracted, the battery 19 is released from the locked state and becomes removable.

FIG. 4 is a block diagram showing a circuit configuration of the radiographic imaging system 1.

As shown in FIG. 4, in the radiation detector 10, a control device 18 has a controller 25 including a general purpose CPU (central processing unit), ROM (read only memory) and RAM (random access memory) In the controller 25, the CPU uses the ROM, and a volatile memory 57 as a work area, and executes various processing according to processing programs stored in the ROM.

The controller 25 includes, as a basic configuration, parts connected thereto, such as interface 51, scan driver 16, signal driver 17, display panel 21, indicator 22, power supply 60, power button 52, resume button 23, reset button 53, data store button 55, non-volatile memory 24, volatile memory 57, lock mechanism 43, and the like, and controls these parts according to operating states of respective parts.

The interface 51 sends and receives signals to and from an external device connected to the connector 20, and the controller 25 can communicate with the external device through the interface 51.

The power supply 60 includes the battery 19 and a voltage detector 62. The battery 19 is connected to the control device 18 and parts connected thereto to supply power to these parts. The voltage detector 62 detects “voltage V” of the battery 19 to send the detected result to the controller 25. The controller 25 receives the detected result of the voltage detector 62, so that it can catch remaining power of the battery 19.

In the embodiment, display in the display panel 21 is changed according to a determinations whether the battery voltage V is “threshold voltage V₁” or more, or not; and the battery voltage V is “reference voltage V₀ (V₀>V₁)” or more, or not.

That is, the battery voltage V satisfies one of the following expressions:
V₀≦V (1)
V₁≦V<V₀ (2)
V<V₁ (3)

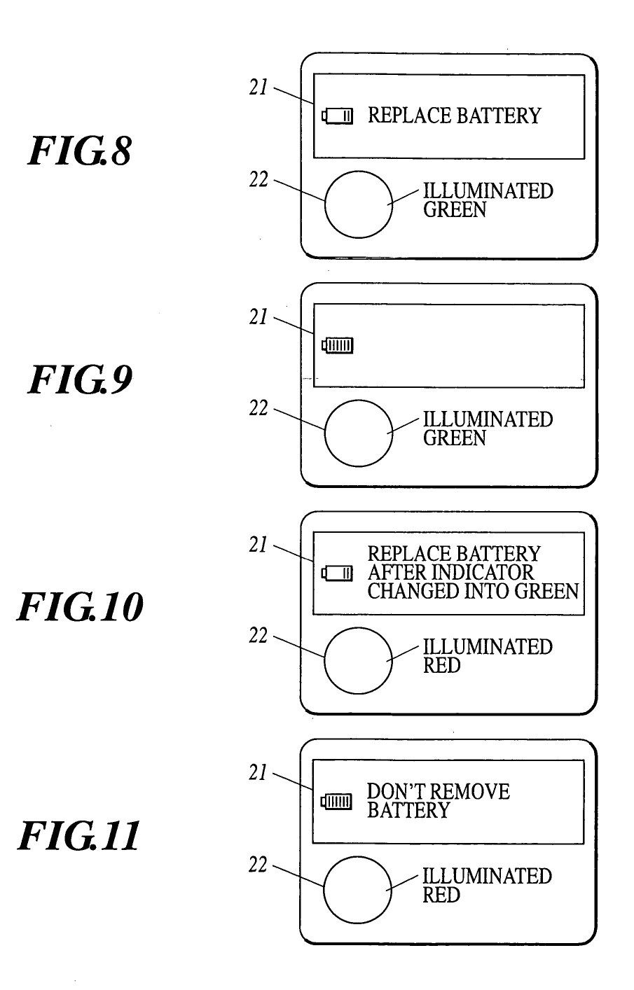

When the battery voltage V satisfies the above expression (1), the controller 25 sends a control signal to the display panel 21 to display that the remaining power of the battery 19 is sufficient (see pictures in FIGS. 9 and 11). When the battery voltage V satisfies the above expression (2), the controller 25 sends a control signal to the display panel 21 to display that the remaining power of the battery 19 is insufficient (see pictures in FIGS. 8 and 10). When the battery voltage V satisfies the above expression (3), power supply from the battery 19 to the display panel 21 is stopped, and the display panel 21 remains in no-display state.

Additionally, the operating state of the lock mechanism 43 changes in association with the voltage V of the battery 19. That is, when the voltage V satisfies the expressions (1) or (2), the controller 25 sends a control signal to the lock mechanism 43, allowing activation of it. When the expression (3) is satisfied, power is stopped supplying from the battery 19 to the lock mechanism 43, and activation of the mechanism 43 is forcibly released.

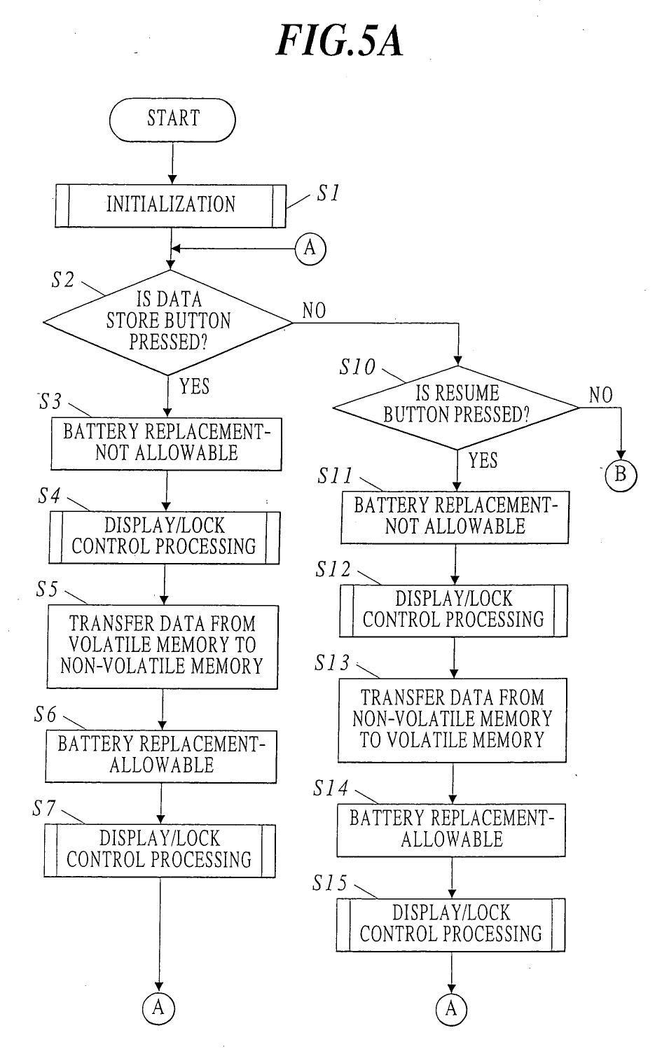

The controller 25 functions as a determination section to determine whether replacement of the battery 19 is allowable according to operating states of configuration parts. According to a state that replacement of the battery 19 is allowable or not, the controller 25 establishes the state (sets a flag indicating the state), and controls actuation or release of the lock mechanism 43 according to the establishment (refer to FIGS. 5-12).

Following press operation of the power button 52, resume button 23, reset button 53 and the data-store button 55 by an operator, the controller 25 also controls respective configuration parts. Specifically, when the operator presses the power button 52, the controller 25 supplies power from the battery 19 to each part to put the radiation detector 10 into a turned-on state, or stops supplying of power from the battery 19 to each part to put the detector 10 into a turned-off state.

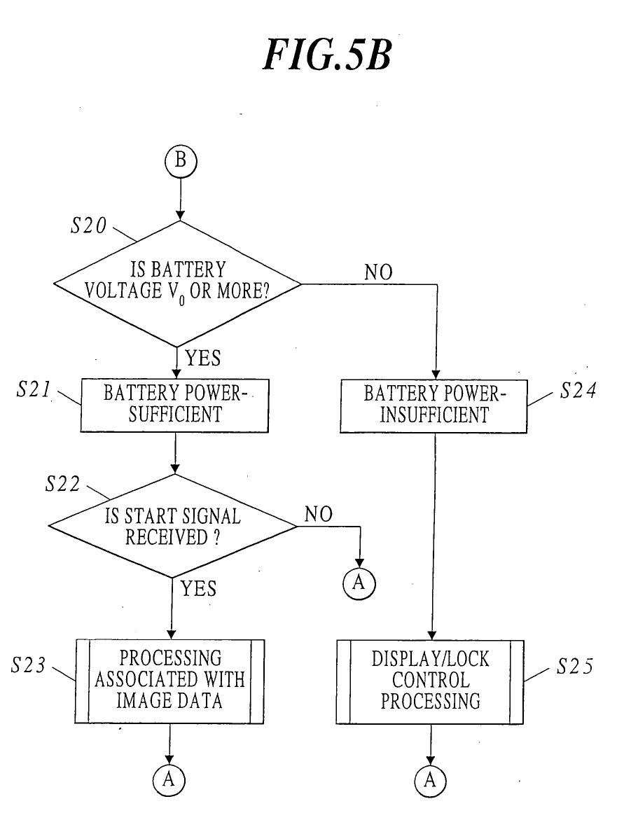

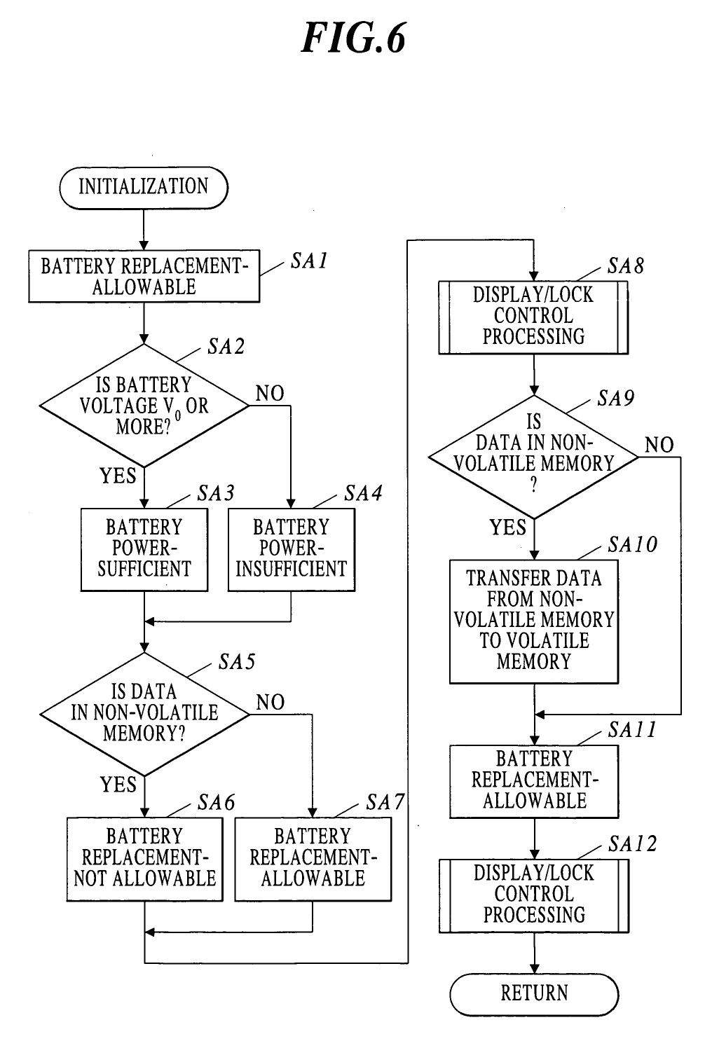

When the operator presses the resume button 23, the controller 25 transfers data from the non-volatile memory 24 to the volatile memory 57. When the operator presses the reset button 53, the controller 25 executes an initialization processing (see FIG. 6) to reset the running state of the radiation detector 10 to a starting state. When the operator presses the reset button 53 with the lock mechanism 43 working, the lock mechanism 43 is also released. When the operator presses the data-store button 55, the controller 25 transfers data from the volatile memory 57 to the non-volatile memory 24.

On the other hand, in the console 3, a control device 30 has a controller 35 including a general purpose CPU (central processing unit), ROM (read only memory) and RAM (random access memory). The controller 35 develops processing programs stored in the ROM into the RAM, and the CPU executes the processing programs.

The controller 35 includes parts connected thereto, such as a display 32, keyboard/mouse 33, an interface 34, and the like, and controls each part according to operating states of these parts. The interface 34 sends and receives signals to and from an external device connected to the connector 31, and the controller 35 can communicate with the external device, such as the radiation detector 10, through the interface 34.

In the radiographic imaging system 1, the connector 20 in the radiation detector 10 and the connector 31 in the console 3 are connected to each other by a member such as a cable, so that the detector 10 can communicate with the console 3 through respective connectors 20 and 31.

Communication between the radiation detector 10 and the console 3 is implemented by wire as described above, but may be implemented by known wireless communication, or by known wire or wireless one through a network. Particularly, when a communication network is applied, it is preferable to use, for example, a wireless LAN (local area network) for realizing connection from the console 3 and the detector 10 to the network.

A description will now be given of the operation or action of the radiographic imaging system 1 with reference to FIGS. 5 to 12.

FIG. 5 is a flowchart showing in a time sequence each processing of a main routine that the controller 25 of the radiation detector 10 executes, and FIGS. 6, 7 and 12 are flowcharts showing in a time sequence each processing of subroutines (initialize processing, display/lock control processing, and processing associated with image data) in the main routine.

When an operator presses the power button 52 to turn on the radiation detector 10, or presses the reset button 53 under the turned-on state of the detector 10, the controller 25 of the detector 10 starts executing each processing of the main routine shown in FIG. 5, and executes first an “initialize processing” (step S1).

The initialize processing is a processing to reset the running state of the detector 10 into a starting state at the time of radiographing the subject M. In the initialize processing, as shown in FIG. 6, the controller 25 establishes that replacement of the battery 19 is allowable (step SA1), thereafter, receiving the detected result of the voltage detector 62, determines whether the voltage V of the battery 19 is not less than a reference voltage V₀ (step SA2).

When the voltage value V of the battery 19 is determined to be not less than the reference voltage V₀, the controller 25 establishes that the remaining power of the battery 19 is sufficient (step SA3) To the contrary, when determined that the battery voltage value V is less than the reference voltage V₀, the controller 25 establishes that the battery power is insufficient (step SA4).

After establishing the remaining power of the battery 19, the controller 25 determines whether data is in the non-volatile memory 24 (step SA5).

As a result, when determined that the data is in the non-volatile memory 24, the controller 25 establishes that replacement of the battery 19 is not allowable (step SA6). When determined that the data is not in the non-volatile memory 24, the controller 25 establishes that replacement of the battery 19 is allowable (step SA7).

After establishing a condition of battery replacement, the controller 25 executes a “display/lock control processing” (step SA8).

The “display/lock control processing” is a processing in which, according to the establishment for the remaining power of the battery 19 (see steps SA3 and SA4), and for the replacement of the battery 19 (see steps SA6 and SA7), the controller 25 controls each displaying state of the display panel 21 and the indicator 22, as well as the activation or release of the lock mechanism 43.

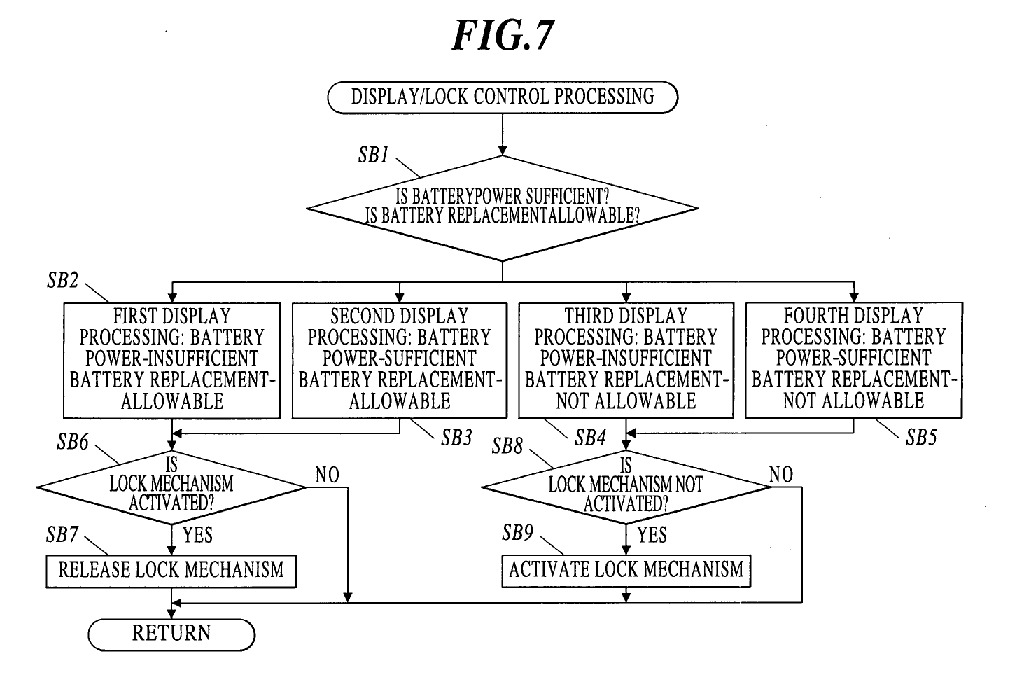

In the “display/lock control processing”, as shown in FIG. 7, the controller 25 determines whether the battery power is sufficient or insufficient (see steps SA3 and SA4), and whether the battery replacement is allowable or not allowable (see steps SA6 and SA7) (step SB1).

As a result, the controller 25 executes any one of first to fourth display processings according to the following four cases of establishments described above:
(1) battery power is insufficient, and battery replacement is allowable;
(2) battery power is sufficient, and battery replacement is allowable;
(3) battery power is insufficient, and battery replacement is not allowable; and
(4) battery power is sufficient, and battery replacement is not allowable.

When the above-described establishment corresponds to the case of (1), the controller 25 executes a first display processing (step SB2). Specifically, the controller 25 sends a control signal to the display panel 21 and the indicator 22, and, as shown in FIG. 8 for example, makes the panel 21 display by a symbol the status that the battery power is insufficient, and makes the display 22 be lit green.

In the first display processing, the controller 25 executes the processing depending on the establishment that remaining power of the battery 19 is insufficient but replacement of the battery 19 is allowable. Characters like “REPLACE BATTERY” displayed in the display panel 21 indicate a determination that the battery replacement is allowable or not, as well as a detected result that the battery voltage V is not less than the reference voltage V₀ or not.

When the above-described establishment corresponds to the case of (2), the controller 25 executes a second display processing (step SB3). Specifically, the controller 25 sends a control signal to the display panel 21 and the indicator 22, and, as shown in FIG. 9 for example, makes the panel 21 display by a symbol the status that the battery power is sufficient, and makes the display 22 be lit green.

When the above-described establishment corresponds to the case of (3), the controller 25 executes a third display processing (step SB4). Specifically, the controller 25 sends a control signal to the display panel 21 and the indicator 22, and, as shown in FIG. 10 for example, makes the panel 21 display by a symbol the status that the battery power is insufficient, and makes the display 22 be lit red.

In the third display processing, the controller 25 executes the processing depending on the establishment that remaining power of the battery 19 is insufficient and replacement of the battery 19 is not allowable. Characters like “REPLACE BATTERY AFTER INDICATOR CHANGED INTO GREEN” displayed in the display panel 21 indicate a determination that the battery replacement is allowable or not, as well as a detected result that the battery voltage V is not less than the reference voltage V₀ or not.

When the above-described establishment corresponds to the case of (4), the controller 25 executes a fourth display processing (step SB5). Specifically, the controller 25 sends a control signal to the display panel 21 and the indicator 22, and, as shown in FIG. 11 for example, makes the panel 21 display by a symbol the status that the battery power is sufficient, and makes the display 22 be lit red.

In the fourth display processing, the controller 25 executes the processing depending on the establishment that remaining power of the battery 19 is sufficient but replacement of the battery 19 is not allowable. Characters like “DON T REMOVE BATTERY” displayed in the display panel 21 indicate a determination that the battery replacement is allowable or not, as well as a detected result that the battery voltage V is not less than the reference voltage V₀ or not.

As to each display style in the display panel 21, such as the display showing that the battery power is sufficient or insufficient, and the display according to the determination result for the battery replacement and the detected result for the battery voltage V, it may be presented by other symbols and characters than those shown in FIGS. 8-11.

Further, in the display/lock control processing, the controller 25, in addition to the first to fourth display processings described above, also controls activation and release of the lock mechanism 43 as described below in synchronism with the display processing.

That is, in the case of above-described (1) or (2), the controller 25 determines whether the lock mechanism 43 is activated (step SB6). When determined that the lock mechanism 43 is activated, the controller 25 sends a control signal to the lock mechanism 43 to make the lock mechanism 43 be released from the activation (step SB7). At this time, the lock mechanism 43, receiving the control signal from the controller 25, moves from the state of projecting in the opening 40 to the state of retracting inside the housing 11. To the contrary, when determined that the lock mechanism 43 is now not activated, the controller 25 sends a control signal to the lock mechanism 43 to maintain the present state. At this time, the lock mechanism 43, receiving the control signal from the controller 25, keeps retracting inside the housing 11.

In the case of above-described (3) or (4), the controller 25 determines whether the lock mechanism 43 is not activated (step SB8). When determined that the lock mechanism 43 is not activated, the controller 25 sends a control signal to the lock mechanism 43 to activate the lock mechanism 43 (step SB9). At this time, the lock mechanism 43, receiving the control signal from the controller 25, moves from the state of retracting inside the housing 11 to the state of projecting in the opening 40. To the contrary, when determined that the lock mechanism 43 is now activated, the controller 25 sends a control signal to the lock mechanism 43 to maintain the present state. At this time, the lock mechanism 43, receiving the control signal from the controller 25, keeps projecting in the opening 40.

In the display/lock control processing described above, regarding the remaining power of the battery 19, when the battery power is sufficient, the state is displayed on the display panel 21, and when insufficient, the state is also displayed on the display panel 21. On the other hand, regarding the replacement of the battery 19, when the battery replacement is allowable, the indicator is turned on to green and the lock mechanism 43 is made released, and when not allowable, the indicator is turned on to red and the lock mechanism 43 is made activated.

In the display/lock control processing, the controller 25 may send to the console 3 a determination result on replacement of the battery 19 and a detected result on the battery voltage V, and the controller 35 of the console 3 may receive the determination result and the detected result through the interface 34 to display these determination result and detected result on the display 32.

After completion of the display/lock control processing described above, the controller 25 returns to the initialize processing and determines whether data is in the non-volatile memory 24 (step SA9). Only when it is determined that the data is in the non-volatile memory 24, the data is transferred from the non-volatile memory 24 to the volatile memory 57 (step SA10). Thereafter, establishing that replacement of the battery 19 is allowable (step SA11), the controller 25 executes the display/lock control processing (see FIG. 7) similar to that described above, according to the contents established by the previous processing (step SA 12).

In the initialize processing described above, under an establishment that replacement of the battery 19 is not allowable, the controller 25 determines whether data is in the non-volatile memory 24, or transfers the data from the volatile memory 57 to the non-volatile memory 24. After the determination and data transfer processing, the controller 25 establishes that battery replacement is allowable, and finishes execution of the initialize processing.

After finishing the initialize processing, the controller 25 returns to the main routine of FIG. 5, and determines whether the data store button 55 is pressed (step S2).

As a result, when determined that the data store button 55 is pressed, the controller 25 establishes that replacement of the battery 19 is not allowable (step S3), and executes the display/lock processing (see FIG. 7), similar to that described above, according to the contents established by the previous processing (step S4). After finishing the display/lock processing, the controller 25 transfers data stored in the volatile memory 57 to the non-volatile memory 24 (step S5), thereafter establishes that battery replacement is allowable (step S6), executes the display/lock processing (see FIG. 7), similar to that described above, according to the contents established by the previous processing (step S7), and makes the processing return to step S2 described above.

Thus, when an operator presses the data store button 55, the controller 25, under establishment that battery replacement is not allowable, transfers data from the volatile memory 57 to the non-volatile memory 24. In other words, when data is stored in the volatile memory 57, or while the data is transferred from the volatile memory 57 to the non-volatile memory 24, the controller 25 determines that replacement of the battery is not allowable.

In this case, since data in the volatile memory 57 is transferred to the non-volatile memory 24, even if detaching and attaching of the battery 19 is carried out to replace the battery 19 after the transfer, the present running state of the radiation detector 10 can be transferred as is to the running state after replacement of the battery 19. Moreover, when the data in the volatile memory 57 is once transferred to the non-volatile memory 24, the data remains in the non-volatile memory 24 regardless of replacement of the battery 19, so that the operator can perform replacement operation of the battery 19 without worrying loss of the stored data.

When determined that the store button 55 is not pressed in step S2, the controller 25 determines whether the resume button 23 is pressed by the operator (step S10).

As a result, when determined that the resume button 23 is pressed, the controller 25 establishes that battery replacement is not allowable (step S11), and executes the display/lock control processing (see FIG. 7), similar to that described above, according to the contents established by the previous processing (step S12). After completion of the display/lock processing, the controller 25 transfers data stored in the non-volatile memory 24 to the volatile memory 57 (step S13), thereafter establishes that battery replacement is allowable (step S14), then executes the display/lock processing (see FIG. 7), similar to that described above, according to the contents established by the previous processing (step S15), and makes the processing return to step S2 described above.

Thus, when an operator presses the resume button 23, the controller 25, under establishment that battery replacement is not allowable, transfers data from the non-volatile memory 24 to the volatile memory 57. In other words, when the data is transferred from the non-volatile memory 24 to the volatile memory 57, the controller 25 determines that replacement of the battery is not allowable.

In this case, since data in the non-volatile memory 24 is transferred to the volatile memory 57, even if replacement of the battery 19 has been previously carried out to replace the battery 19, the running state of the radiation detector 10 before replacing the battery 19 can be transferred as was to the running state after replacement of the battery 19, so that the running state of the radiation detector 10 can resume the original running state that was before replacing the battery 19.

Alternatively, when a sensor for detecting replacement of the battery 19 is provided in the housing 11, and detects that a new battery 19 is attached to the radiation detector 10 with replacement of the battery 19, the controller 25 may automatically execute each processing in steps 11-15 described above to make the running state of the detector 10 resume the original state that was before replacing the battery 19, regardless of pressing the resume button by the operator.

When determined that the resume button 23 is not pressed in above-described step S10, the controller 25 determines, according to the detected result of the voltage detector 62, whether the battery voltage V is not less than the reference voltage V₀ (step S20).

As a result, when determined that the battery voltage V is not less than the reference voltage V₀, the controller 25 establishes that the battery power is sufficient (step S21), and determines whether the controller receives a “start signal” from the console 3, the start signal instructing start of radiographic imaging of a subject M (step S22).

As a result, when determined that the controller receives a start signal, the controller 25 executes a “processing associated with image data” (step S23), and when determined that the controller does not receive a start signal, the controller 25 makes the processing return to above-described step S2.

The “processing associated with image data” is a processing associating with the image data of the subject M, and more particularly, the controller generates the image data of the subject M by detecting radiation transmitted through the subject M, and sends the generated image data to the console 3.

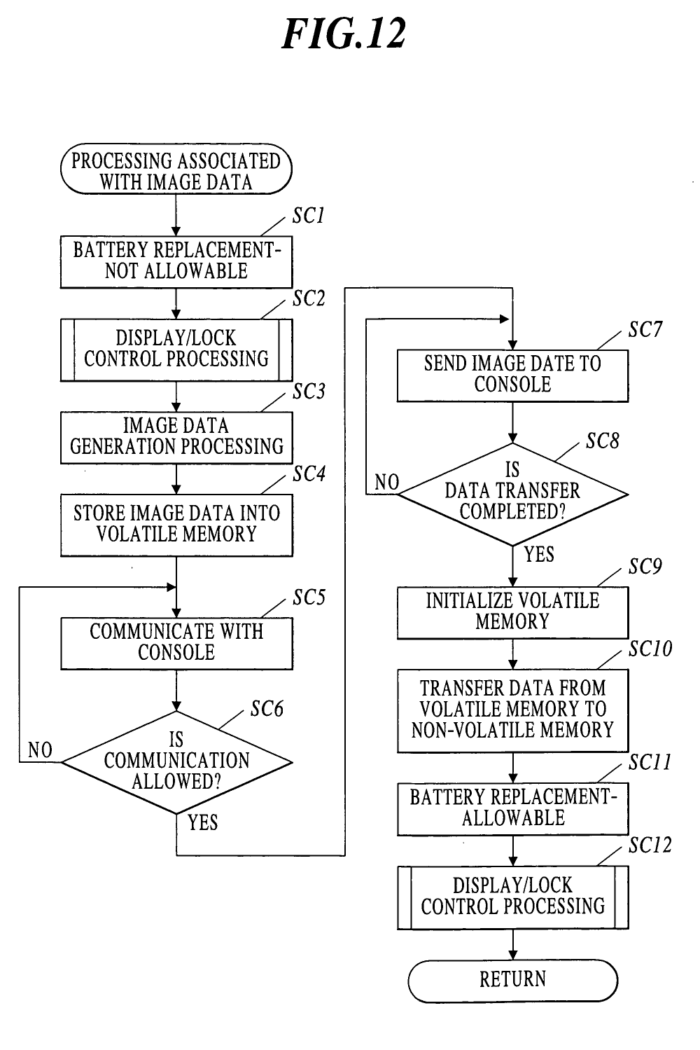

In the processing associated with image data, as shown in FIG. 12, the controller establishes that battery replacement is not allowable (step SC1), and executes the display/lock processing (see FIG. 7) similar to that described above, according to the contents established by the previous processing (step SC2).

After completion of the display/lock processing, the controller 25 executes an image data generation processing (step SC3). Specifically, the controller 25 sends a control signal to the scan driver 16 and the signal driver 17, makes the scan driver 16 send pulses to respective photoelectric conversion elements in the fluorescent detection panel 15, makes the signal driver 17 read as signals electric energy stored in the respective photoelectric conversion elements, and generates the “image data” based on the result read by the signal driver 17.

Here, the image data generation processing is executed assuming that the radiographic imaging of the subject M has been previously carried out, and the radiographic imaging includes the following operations. That is, the imaging apparatus 2 irradiates the subject M laid on the bed 6 with radiation radiated from the radiation source 4 through the diaphragm 5, and the radiation transmitted through the subject M is incident on the radiation detector 10. When the radiation is incident on the radiation detector 10, the radiation, scattered component of which is absorbed and eliminated by the grid 12 of the detector 10, is incident on the scintillator 14, and the scintillator 14 emits fluorescence with intensity according to the intensity of the radiation. When the scintillator 14 emits fluorescence, respective photoelectric conversion elements in the fluorescent detection panel 15 receive fluorescence emitted from the scintillator 14, and store electric energy according to the received quantity of light.

After the image data of the subject M is generated, the controller 25 stores and holds the image data in the volatile memory 57 temporarily (step SC4).

After the image data has been held in the volatile memory 57, the controller 25 communicates with the controller 35 of the console 3 to check whether the console 3 permits receipt of the image data (step SC5), and repeatedly determines from the communication result whether the image data is possible to be sent to the console 3 (step SC6).

When determined that the image data is possible to be sent, the controller 25 sends the image data to the console 3 through the connector 20 (step SC7), and determines repeatedly whether transmission of the image data has been completed (step SC8).

When determined that the transmission of the image data has been completed, the controller 25 initializes the volatile memory 57 (step SC9), and transfers data held in the volatile memory 57 (except the image data) from the volatile memory 57 to the non-volatile memory 24 (step SC10).

At this time, when the console 3 receives the image data, the controller 35 of the control device 30 executes image processing for the image data to generate a radiographic image, and displays the radiographic image on the display 32 as a radiographic image of the subject M.

After the data has been transferred from the volatile memory 57 to the non-volatile memory 24, the controller 25 establishes that battery replacement is allowable (step SC11), executes the display/lock processing (see FIG. 7) similar to that described above, according to the contents established by the previous processing (step SC12), and makes the processing return to step S2 in the main routine of FIG. 5.

In the processing associated with image data described above, the image data is sent to the console 3 under the establishment that battery replacement is not allowable, that is, the controller 25 determines that replacement of the battery 19 is not allowed during communication with the console 3. Further, even after transmission of the image data, the controller 25 transfers the data from the volatile memory 57 to the non-volatile memory 24 under the establishment that battery replacement is not allowable. In other words, the controller 25 determines that replacement of the battery 19 is not allowed when the data is held in the volatile memory 57, or while the data is transferred from the volatile memory 57 to the non-volatile memory 24.

As a result of determination in above-described step S20, when determined that the battery voltage V is less than the reference voltage V₀, the controller establishes that battery power is insufficient (step SC24), then executes the display/lock processing (see FIG. 7) similar to that described above, according to the contents established by the previous processing (step SC25), and makes the processing return to step S2 described above.

In the radiographic imaging system 1, when data transfer between the volatile memory 57 and the non-volatile memory 24 from one side to the other, communication between the radiation detector 10 and the console 3, and the like are to be carried out, the controller 25 of the radiation detector 10 executes the display/lock control processing in advance under the establishment that replacement of the battery 19 is not allowable. With this processing, the operator can easily determine that replacement of the battery 19 is allowable or not, and carry out charging or replacement of the battery 19 depending on the situation, watching the display of the display panel 21 and the indicator 22 and the operation state of the lock mechanism 43, and further, there can be prevented erroneous detachment of the battery 19 in the term that the radiation detector 10 is running or in communication.

The entire disclosure of Japanese Patent Application No. 2004-269951 which was filed on Sep. 16, 2004 and Japanese Patent Application No. 2004-283702 which was filed on Sep. 29, 2004 including specifications, claims, drawings and abstracts, are incorporated into the present invention in its entirety.

What is claimed is:

1. A radiation detector comprising:
a replaceable battery; and
a determination section to determine whether replacement of the battery is allowable or not.

2. The radiation detector of claim 1, wherein the determination section determines that the replacement of the battery is not allowable while the detector is in communication with an external device.

3. The radiation detector of claim 1, further comprising a volatile memory, wherein when the volatile memory holds data, the determination section determines that the replacement of the battery is not allowable.

4. The radiation detector of claim 3, further comprising:
a non-volatile memory; and
a switch to instruct data transfer from the volatile memory to the non-volatile memory,
wherein the determination section determines that the replacement of the battery is not allowable while the data transfer is performed from the volatile memory to the non-volatile memory by operation of the switch.

5. The radiation detector of claim 1, further comprising a volatile memory and a non-volatile memory, wherein the determination section determines that the replacement of the battery is not allowable while data transfer is performed from the volatile memory to the non-volatile memory.

6. The radiation detector of claim 1, further comprising a display unit to display a state that the replacement of the battery is not allowable based on a determination result of the determination section.

7. The radiation detector of claim 1, further comprising a display unit to display a state that the replacement of the battery is allowable based on a determination result of the determination section.

8. The radiation detector of claim 1, further comprising:
a voltage detector to detect a voltage of the battery;
a display unit to display a content according to a determination result of the determination section and a detected result of the voltage detector.

9. The radiation detector of claim 1, further comprising a lock mechanism not to permit replacement of the battery under operating conditions, wherein the lock mechanism operates when the determination section determines that the replacement of the battery is not allowable.

10. The radiation detector of claim 9, further comprising a reset part to instruct release of the lock mechanism from activation, wherein activation of the lock mechanism is released through an operation of the reset part.

11. The radiation detector of claim 1, further comprising a lock mechanism not to permit replacement of the battery under operating conditions, wherein activation of the lock mechanism is released when the determination section determines that the replacement of the battery is allowable.

12. The radiation detector of claim 1, further comprising a lock mechanism not to permit replacement of the battery under operating conditions, wherein the lock mechanism is activated through a power supply from the battery and activation of the lock mechanism is released by a voltage drop of the battery.

13. A radiographic imaging system comprising a radiation detector and a console, capable of communicating with each other,
wherein the radiation detector comprises: a replaceable battery, a determination section to determine whether replacement of the battery is allowable or not, and a detector interface to send a determination result of the determination section as a signal, to the console; and
the console comprises: a console interface to receive the signal from the radiation detector, and a display unit to display the determination result of the determination section based on the received signal.

14. A radiation detector comprising:
a replaceable battery;
a volatile memory;
a non-volatile memory;
a switch to instruct data transfer from the volatile memory to the non-volatile memory; and
a display unit to display a state that replacement of the battery is allowable,
wherein the data transfer is performed from the volatile memory to the non-volatile memory by operation of the switch, and after the data transfer, the display unit displays a state that replacement of the battery is allowable.

15. The radiation detector of claim 14, wherein it is determined whether data is in the non-volatile memory or not when replacing the battery, and after the determination, the display unit displays the state that replacement of the battery is allowable.

16. The radiation detector of claim 14, wherein the data transfer is performed from the non-volatile memory to the volatile memory when replacing the battery, and after the data transfer, the display unit displays the state that replacement of the battery is allowable.

17. A radiographic imaging system comprising a radiation detector and a console, capable of communicating with each other,
wherein the radiation detector comprises: a replaceable battery, a volatile memory, a non-volatile memory, a switch to instruct data transfer from the volatile memory to the non-volatile memory, and a detector interface to send a state that replacement of the battery is allowable, as a signal to the console; and
the console comprises: a console interface to receive the signal from the radiation detector, and a display unit to display the state that replacement of the battery is allowable, based on the received signal, and
the radiation detector performs data transfer from the volatile memory to the non-volatile memory by operation of the switch, and after the data transfer, the display unit of the console displays a state that replacement of the battery is allowable.
